(19) United States
(12) Patent Application Publication
(10) Pub. No.: US 2014/0089409 A1
(43) Pub. Date: Mar. 27, 2014

(54) RATING SYSTEM FOR A SOCIAL NETWORK OR DATING SERVICE

(71) Applicant: Sergio Moutela, Union, NJ (US)

(72) Inventor: Sergio Moutela, Union, NJ (US)

(21) Appl. No.: 14/029,161

(22) Filed: Sep. 17, 2013

Related U.S. Application Data
(60) Provisional application No. 61/704,028, filed on Sep. 21, 2012.

(51) Int. Cl. H04L 29/08

(52) U.S. Cl. CPC H04L 67/306
USPC 709/204

(57) ABSTRACT

A rating system for a social network or dating service comprising at least one social network or dating service on a server; and a computer which displays a widget interface of said at least one social network or dating service; wherein a first user uses said widget interface to search and display a second user's profile page on said widget interface, wherein said first user enters in a rating of said second user and said rating is stored on said server of said at least one social network or dating service and displayed on said second user's profile page.

### BACKGROUND OF THE INVENTION

The present invention relates to a rating system and, more particularly, to a rating system for a social network or dating service.

Currently, in the field of online and offline dating services, individuals take questionnaires offered by the services for the purpose of matching couples based on compatibility. Once the individuals begin dating their matches, they are left to fend for themselves with no other assistance from the dating service.

Therefore, the user risks wasting their time and potentially risks being harmed. Online dating services are also criticized for failing to provide adequate amounts of background information to the user, placing them in direct danger.

As can be seen, there is a need for a rating system on the social networks or dating services to provide users with further information on their match.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rating system for a social network or dating service. The rating system includes a computer and at least one social network or dating service on a server. The computer displays a widget interface of the at least one social network or dating service. A first user uses the widget interface to search and display a second user or individual's page on the widget interface. The first user enters in a rating of the second user, and the rating is stored on the server. The rating is then displayed on the second user's page.

In an embodiment of the invention, the rating system is utilized on at least one social network or dating service. The social network may include Facebook®, however it is envisioned that other social network or dating services may be used. The at least one social network or dating service is supported on a server. The server may be accessed by a computer. The computer may include a tablet, laptop, desktop, smart phone, smart device, or the like. In certain embodiments, the computer accesses the server using a software program, such as a web browser. The program accesses the server using the internet, intranet, extranet, host server, internet cloud or the like. The social network or dating service may be displayed on the computer as a widget interface

In certain embodiments, a user may log onto the social network or dating service using the widget interface. The social network or dating service may include a member service. The login of the social network may include a username and/or password to identify the user that is logging on. Once the user is logged into the social network or dating service, the user may browse through multiple profile pages owned by individuals. Such profile pages are stored on the social network or dating service. In certain embodiments, the profile pages may include pictures and descriptions of the individual which owns the profile page. Once a user is displaying an individual's profile on the widget interface, the user may post a rating or review on the profile, which is in turn saved onto the social network or dating service and further displayed on the individual's profile page for users or members to see.

As mentioned above, the rating or review posted by the user may be viewed by users or members because the information is stored and displayed on the individual's profile page. In certain embodiments, users may browse through and/or search for individuals. The posted information allows users to search and find pertinent information about an individual in which the user may be potentially or currently dating. In certain embodiments, a user may search for an individuals profile using geographic information, gender, star rating, relationship status, a combination thereof, or the like. Once a user has found the information sought after, the information may be used to influence the user's decision on whether to pursue a relationship with the individual or not.

In certain embodiments, the rating process involves a user posting a review on an individuals profile regarding the characteristics of the individual. The profile rating may further be broken down into a number of categories relating to the individuals potential for relationship success. For example, the rating system may be based on multiple categories with each category including between one and five stars which a user may rate the individual. However, the rating system may be performed in many different methods, all of which are encompassed herein.

In embodiments of the invention, an email, text message, or push notification may be sent to an individual alerting them when another user has left a rating and/or review on their profile. In certain embodiments, the individual who was rated may leave a rebuttal comment. For example if the rating by the user was incomplete or biased, the individual may want to preserve their reputation. In certain embodiments, the individual may only leave one rebuttal for each user rating or review. However, it is envisioned the individual may leave as many rebuttals as they would like.

A method of using the invention may include the following steps: logging into a social network or dating service using a widget interface on a computer; searching for an individual on the social network by entering in certain criteria; entering in a rating on the individual; and viewing a display of the rating on the individual's page.

By allowing users to view and post reviews on individuals they are currently dating or have dated in the past, the social network or dating service provides useful information so that users may better evaluate their dating decisions. Since a user may search for feedback on other individuals on the social network or dating service, the user has immediate access to the information. The user may therefore make a more appropriate judgment on whether someone new they are dating is a viable option for committing their time and effort towards.

It should be understood, of course, that the foregoing relates to exemplary embodiments of the invention and that modifications may be made without departing from the spirit and scope of the invention as set forth in the following claims.

1. A rating system for a social network or dating service comprising:
at least one social network or dating service on a server; and
a computer, wherein said computer displays a widget interface of said at least one social network or dating service;
wherein a first user uses said widget interface to search and display a second user s profile page on said widget interface, wherein said first user enters in a rating of said second user, and wherein said rating is stored on said server of said at least one social network or dating service and displayed on said second user's profile page.

2. A method for rating another person with whom you have had or currently have a relationship, the method comprising the steps of;
accessing a rating widget on a smartphone or a website to access a rating server;
synching information on the rating server with connections on a social network server;
grading a connection with whom you have had or currently have the relationship wherein the grade is stored on the rating server.

3. The method of claim 2 wherein the social network server is facebook or linkedin.

4. The method of claim 2 wherein the grading step is limited to only those with whom you are connected on the social network server.

5. The method of claim 2 wherein the relationship is a ex girlfriend, ex boyfriend, friend, acquaintance, or business relationship.

6. A method for providing a rating service wherein first person may rate a second person with whom the first person have had or currently have a relationship, the method comprising the steps of:
receiving from the first person a grade of the second person only if the first person is a member of the rating service;
storing the grade on a server of the rating service;
transmitting the grade only to members of the rating service only if the first and second people are connections on a different social network.

7. The method of claim 6 wherein the receiving step is accomplished with a Smartphone widget which is provided to the first person by the rating service.

8. The method of claim 6 further comprising the step of displaying, the grade on the second person's page on the different social network.

9. The method of Claim to further comprising the step of displaying categories to the first person so that the person is limited to grading the second person as defined by the categories.
